(19) United States
(12) Patent Application Publication
(10) Pub. No.: US 2005/0188173 A1
(43) Pub. Date: Aug. 25, 2005

(54) Physical domain separation

(76) Inventors: Robert Hasbun, Placerville, CA (US); John H. Wilson, Hillsboro, OR (US)

Correspondence Address: TROP PRUNER & HU, PC, 8554 KATY FREEWAY, SUITE 100, HOUSTON, TX, 77024, US

(21) Appl. No.: 10/785,881

(22) Filed: Feb. 24, 2004

(51) Int. Cl. G06F 12/08

(52) U.S. Cl. 711/203

(57) ABSTRACT

In one embodiment, the present invention includes a method to execute a first process in a first physical domain and execute a second process in a second physical domain. The processes may be managed such that each process cannot access physical memory of the other physical domain, but may be able to access physical memory in any partition of its associated physical domain.

### BACKGROUND

Operating systems (OS) can support multiple execution contexts in which a plurality of independent services and applications are implemented. Theoretically, these execution contexts can be implemented as collections of processes in which each process is wholly contained within its own virtual address space. This isolation ensures that processes cannot accidentally or maliciously damage each other, nor can secrets leak or be stolen across virtual address boundaries.

However, for both performance and programming model reasons, operating systems often break down the strong barriers between processes; shared memory communication is much faster than a formal inter-process communication (IPC) facility; and shared libraries between processes provide convenience, function, and performance benefits. The architectures of all known commercial operating systems have evolved in this way.

The breakdown of the formal barriers between processes has had the deleterious effect of introducing security vulnerabilities and has made it very difficult for applications and services to protect the integrity of the data they are processing.

To date, there have been two general approaches to provide isolation between processes. First, a microkernel-based operating system approach does not rely on any hardware facility beyond virtual addressing, but experience has shown (repeatedly) that it is very expensive and time-consuming to build such an operating system that can support legacy applications, and it suffers from severe performance problems. Second, virtual machine systems, which provide abstraction at a higher level than a microkernel OS, are implemented so that each execution context is contained within its own virtual machine with (naturally) strong boundaries between virtual machines. These virtual machines can (optionally) be optimized with special-purpose hardware. The IPC within a virtual machine can be optimized as described above, allowing existing operating systems applications and programming models to apply within a virtual machine. The protection boundary is between virtual machines, and the communication between virtual machines has a significant network-like overhead.

Neither of these approaches has been able to provide the necessary security, performance, programming model, and legacy support required. A need thus exists to not compromise security for the sake of performance or programming convenience.

### BRIEF DESCRIPTION OF THE DRAWINGS

FIG. 1 is a block diagram of a system in accordance with one embodiment of the present invention.

FIG. 2 is a block diagram of memory structures in accordance with one embodiment of the present invention.

FIG. 3 is a block diagram of a processor in accordance with one embodiment of the present invention.

FIG. 4 is a flow diagram of a method in accordance with one embodiment of the present invention.

FIG. 5 is a flow diagram of a context switching method in accordance with an embodiment of the present invention.

FIG. 6 is a block diagram of a system in accordance with one embodiment of the present invention.

### DETAILED DESCRIPTION

In various embodiments, separation of different physical domains of a system may be effected. As used herein, a “physical domain” is one or more physical partitions of memory. That is, a physical domain is directly mapped to a set of physical partitions of memory. In turn, a physical partition of memory is a section of contiguous physical memory.

In certain embodiments, the system may be a mobile platform, such as a cellular telephone, personal digital assistant (PDA), personal computer, or the like. The OS may be a code base having a reentrant architecture. In various embodiments, such an OS may be a legacy OS having modifications to support an embodiment of the present invention, or another such OS hereafter developed. As used herein, the term “legacy” means a presently existing OS (or a future OS) that as originally available cannot perform in accordance with an embodiment of the present invention (without modification).

An OS may be modified (or specially developed) to provide multiple physical domains. In such an OS architecture, a plurality of physical domains may be present to execute various user applications and system services. Multiple physical domains may be created using this architecture which, in certain embodiments, may be based upon functional/logical partitioning.

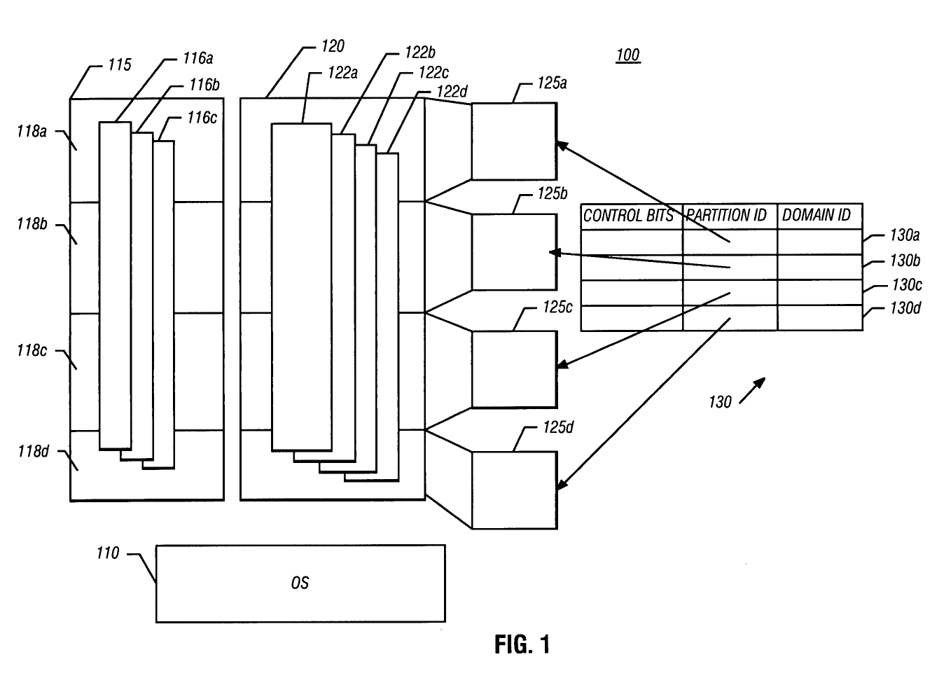

Referring now to FIG. 1, shown is a block diagram of a system in accordance with one embodiment of the present invention. As shown in FIG. 1, system 100 includes an OS 110, which in one embodiment may be a legacy OS and may include the OS kernel to perform system management functions, such as memory and file management and allocation of system resources. In other embodiments, OS 110 may be a microkernel-based architecture.

As further shown in FIG. 1, a first physical domain 120 and a second physical domain 115 are present that each includes a plurality of processes 122a-d and 116a-c, respectively. As used herein the term “process” means code executing inside a single virtual address space, i.e., a context where a context includes the virtual address space.

First domain 120 may be formed of a plurality of physical partitions 125a-125d. While each partition 125a-125d is a contiguous section of physical memory that may be of equal size, first domain 120 need not be necessarily contiguous. In certain embodiments, physical partitions 125a-125d may each be a one Megabyte (MB)-sized partition of physical memory. However in other embodiments, different granularities are possible. Further, in certain embodiments such granularities may be configurable. Also, in other embodiments more or fewer partitions may be present in physical domains, as desired.

Within a given domain, such as first domain 120, all physical addressing in the domain may be limited by a processor (not shown in FIG. 1) to the domain partitions. That is, a given domain is not allowed to physically address memory spaces outside of the partitions that form the domain. In contrast, OS 110, while being isolated within its own domain, may not be so limited in its addressability.

As further shown in FIG. 1, a memory structure 130 may include a plurality of entries 130a-d and in one embodiment, memory structure 130 may be supported by a cache or other temporary storage of most recently used memory partitions. For example, memory structure 130 may be located in a level one (L1) or level two (L2) cache associated with a processor. As shown in FIG. 1, memory structure 130 may include, for each entry, one or more control bits, a partition identification (partition ID), and a domain identification (domain ID). In an embodiment in which each partition is 1 MB, the partition ID may correspond to the high-order 12 bits of the physical address of an associated partition. In the example shown in FIG. 1, each partition ID associated with entries 130a-d corresponds to one of physical partitions 125a-d. While shown in the embodiment of FIG. 1 as including four entries, it is to be understood that in other embodiments greater or fewer entries may be present.

In other embodiments, instead of such a memory structure a plurality of architectural control registers may be present in a processor, each of which addresses a respective physical partition. For example, four control registers define first domain 120. As discussed above, in an embodiment in which each partition is 1 MB, each control register may include the high-order 12 bits of the physical address of the respective partition. In embodiments using control registers, on a context switch the control registers may be reloaded with different values to identify a different domain.

Because there are a plurality of processes 122a-122d within first domain 120, such processes may share memory space within first domain 120. However, the processes may be prevented from accessing memory locations outside first domain 120, in various embodiments.

For example, any of processes 122a-d of first domain 120 may be prevented from accessing memory locations in physical partitions 118a-d of second domain 115. Similarly, processes 116a-c, grouped within second domain 115 may access any of partitions 118a-d. However, processes 115a-c may be prevented from accessing any locations in partitions 125a-d.

In user mode, addressability may be limited to the physical domain in which an application is being executed; however in non-user mode, no such limitations may be present.

In various embodiments, a processor in accordance with an embodiment of the present invention may include memory accessing extensions, such as hardware registers. In one embodiment, a processor may have a reduced instruction set computing (RISC) architecture, such as an architecture based on an Advanced RISC Machines (ARM) architecture. For example, in one embodiment a processor may be a 32-bit version of an XSCALE™ processor available from Intel Corporation, Santa Clara, Calif.

In various embodiments, the OS may segment mutually-trusted applications and services in the same domain. In such manner, these mutually-trusted applications and services may share memory, thus providing performance gains while maintaining a protection boundary around the set. While what is considered mutually-trusted may vary in different usage models, as an example a word processing application and an email application may be segmented into a single domain. Further, secure applications, such as the downloading of code updates and the downloading of secure digital content may share a given domain.

In certain embodiments, applications may include trusted and non-trusted applications. User applications may run in a domain where, if they were to corrupt memory or drivers, the impact would be limited to the user application environment. In certain embodiments, a trusted domain may include a trusted JAVA™ application (or set of trusted JAVA™ applications and services) that executes in a trusted JAVA™ runtime environment of the trusted domain.

In certain embodiments, the scheduling of tasks may be coherent so that the OS is cognizant of all tasks running on the platform, even though the environments the tasks are running in are in physically different domains. In one embodiment, an OS scheduler may perform such task coherency. Thus during execution, if a given action is to be taken on a task, such action may be carried out in the secure partition. Such actions may include, for example spawning, killing, terminating, pending, or synchronizing a task.

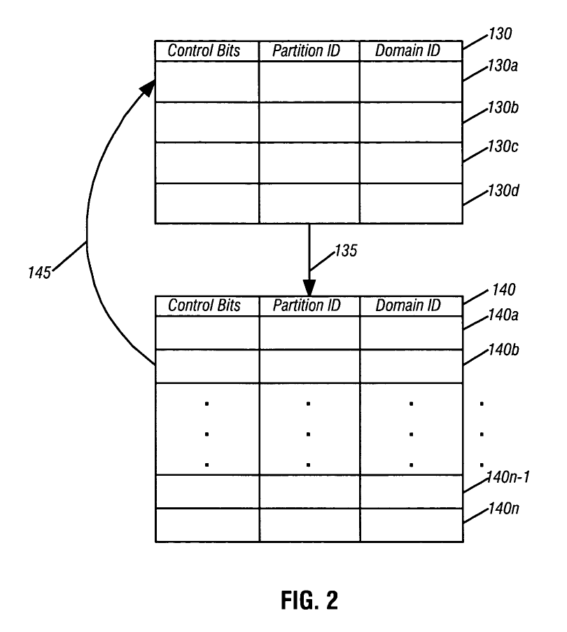

Referring to FIG. 2, shown is a block diagram of memory structures in accordance with one embodiment of the present invention. As shown in FIG. 2, a first memory structure 130 and a second memory structure 140 are shown. First memory structure 130 may be similar to memory structure 130 of FIG. 1, and may be a domain lookaside buffer (DLB) in accordance with an embodiment of the present invention. Such a DLB may be local storage that acts as a cache of recently used partition addresses. In such manner, DLB 130 may act as a cache to provide faster access to requested data, much in the same way as a translation lookaside buffer acts as a cache to store recently used memory addresses.

In the embodiment shown in FIG. 2, DLB 130 includes four entries 130a-130d. While shown in the embodiment of FIG. 2 as including four entries, the scope of the present invention is not so limited, and a given DLB may include more or fewer entries as desired by a particular architectural scheme. As shown in FIG. 2, each entry 130 may include a domain identification portion (a domain ID) which identifies the physical domain associated with a memory partition, a partition identification portion (a partition ID) which may correspond to a portion of a physical address, such as a M number of high-order bits of a physical address of the memory partition, and one or more control bits that may be used in a particular embodiment to represent various states, such as a reserved state of the entry (i.e., via a valid bit).

In one embodiment, each entry may be 32 bits and may include a 16-bit domain ID to identify a given domain of the system, a partition ID, which may be the 12 most significant bits of a physical address of a memory partition (in an embodiment in which physical partitions are each 1 MB), and four control bits, one of which may be a valid bit. The other control bits may be used for other desired functions.

As further shown in FIG. 2, a second memory structure 140 may be present, which may be a domain table 140. Such a domain table may include the same information as DLB 130, but may include additional entries to map the complete physical memory space available. In such manner, domain table 140 may include a partition ID, a domain ID and control bits for each physical partition of memory associated with a domain. In security terms, table 140 may be considered an access control list for physical memory partitions. Thus, domain table 140 controls access to physical address space. In such manner, physical domains may be directly mapped to physical partitions of memory.

In light of the hierarchical structure of memory structures 130 and 140, if a partition ID is not present in one of entries 130a-130d, a domain table walk may occur in which a requested physical address is compared against entries 140a-140n of domain table 140.

In one embodiment, upon a domain table walk (shown by arrow 135) if an entry corresponding to a physical address is found (e.g., entry 140b, as shown in FIG. 2), that entry may be loaded into DLB 130, as shown by arrow 145. In turn, a least recently used entry may be removed from DLB 130. Alternately, another scheme may dictate which entry is to be removed (if DLB 130 is full). In various embodiments, DLB 130 may be structured in one of any number of well known cache control schemes, including for example, set associative, direct mapped, or the like.

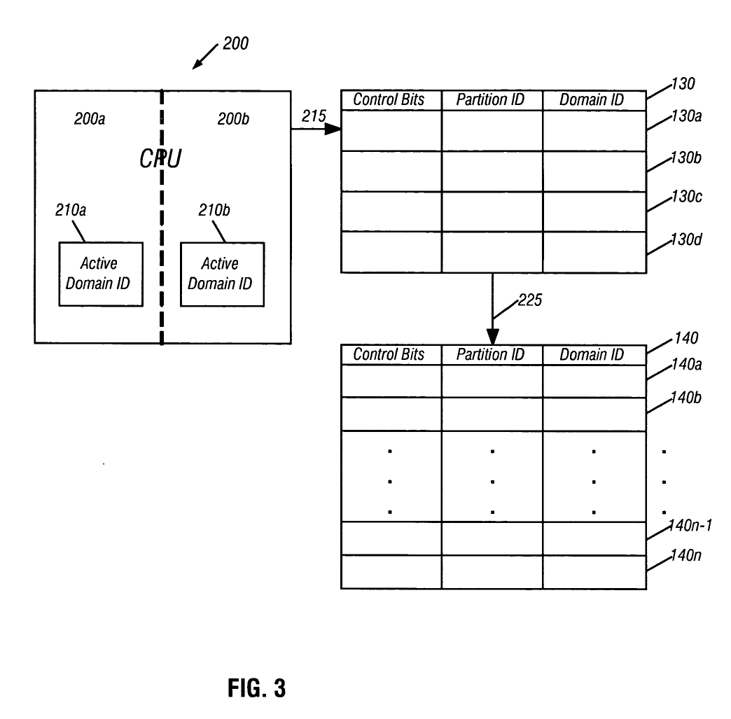

Referring now to FIG. 3, shown is a block diagram of a processor in accordance with one embodiment of the present invention. As shown in FIG. 3, a processor 200, which may be a central processing unit (CPU), may include a plurality of processing cores, such as a first processor core 200a and a second processor core 200b. In some embodiments, first and second processors may be physical processors of a multicore processor and in other embodiments, such processors may be logical processors (e.g., of a multithreaded processor), although the scope of the present invention is not so limited. In other embodiments, a single processor may be present.

As further shown in FIG. 3, each processing core 200a and 200b may include a hardware register 210 (respectively, registers 210a and 210b). Each hardware register 210 may include an identifier for the active domain for that processor (i.e., an active domain ID). In various embodiments, the active domain ID may correspond to the domain ID portion of the entries in data structures 130 and 140. As will be discussed more fully below, hardware register 210 may be used by processor 200 to determine whether a memory location in a physical partition desired to be accessed by a process is associated with the current domain being processed. If it is, the memory access may be allowed. If not, an exception, fault, or other error may be generated, indicating that the access is not allowed.

As shown further in FIG. 3, upon receipt of such a physical address, CPU 200 may be programmed to send at least a portion of the physical address (i.e., a high-order M bits of the address) to DLB 130 and/or domain table 140 (via arrows 215 and 225). As an example, entries in DLB 130 may be compared to the physical address to determine if there is a hit. If not, the address may be provided to domain table 140 (shown by arrow 225) to determine whether a hit occurs there. In an alternate embodiment, only a single memory structure may be present. In alternate embodiments, instead of such memory structures, one or more control registers may be present in the processor (or elsewhere) to determine whether a given physical address is in a currently running domain.

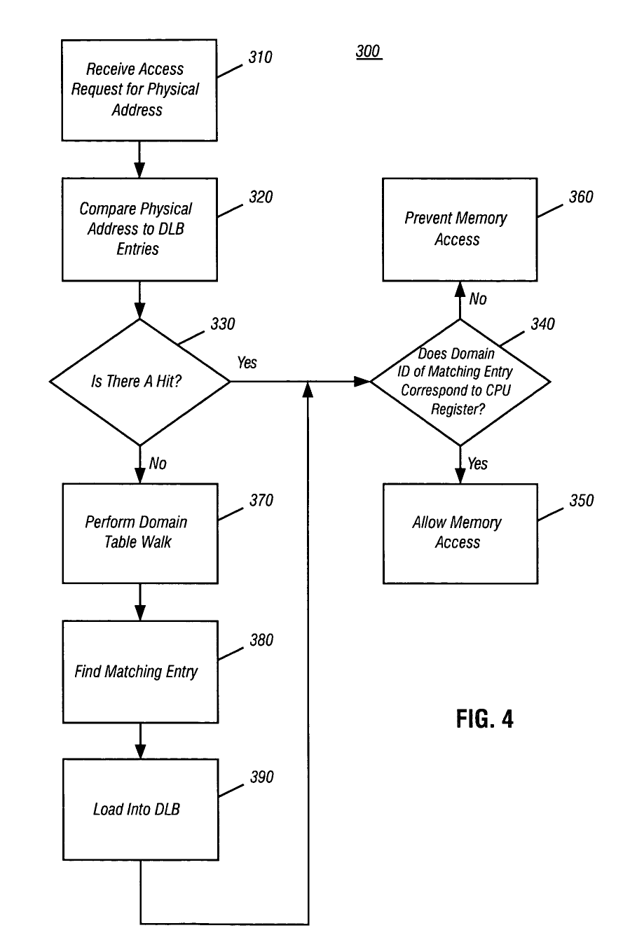

Referring now to FIG. 4, shown is a flow diagram of a method in accordance with one embodiment of the present invention. As shown in FIG. 4, method 300 may begin by receiving an access request for a given physical address (i.e., a given physical memory location) (block 310). Such a request may be received by a processor running a given process. For example, the process may be a task associated with an application being executed in a first domain of a multi-domain system.

As further shown in FIG. 4, the method may continue by comparing the physical address to entries in a DLB (block 320). As discussed above, in certain embodiments, such entries in a DLB may include at least a portion of a physical address (i.e., a partition ID). Next, the method may determine whether there is a hit (i.e., a match) between high-order M bits of the physical address and an entry in the DLB (diamond 330).

If a hit occurs, next the method may determine whether the domain ID of the matching entry matches the current domain ID as stored in a hardware register of the processor (diamond 340). If the domain IDs match, this indicates that the memory access is for a physical memory location in a physical partition of the currently running domain. Accordingly the memory access is allowed (block 350). Alternately, if there is no match, this indicates that the memory access request does not correspond to the currently running domain and accordingly the memory access is prevented (block 360). For example, such memory access denial may be indicated by an exception, a fault, or otherwise.

Alternately, if it is determined that there is not a hit at diamond 330, a domain table walk may be performed (block 370), and a domain table may be searched to find a matching entry (block 380). The matching entry may then be loaded into the DLB (block 390). Further, control may pass to diamond 330 to test whether the domain ID of the matching entry corresponds to a domain ID in a processor register, as discussed above.

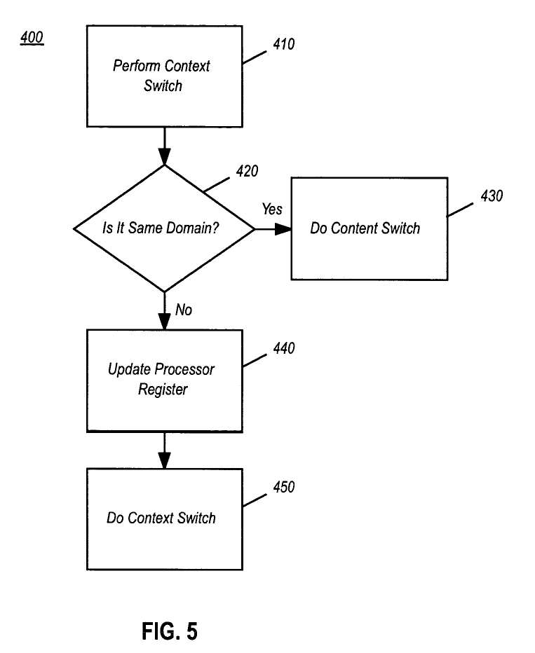

Referring now to FIG. 5, shown is a flow diagram of a context switching method in accordance with an embodiment of the present invention. As shown in FIG. 5, method 400 may begin by receiving a command to perform a context switch (block 410). Such a context switch may cause a second process to be executed in place of a currently running process. A domain switch may be accomplished in a variety of ways. In one embodiment, a kernel services interrupt may effect a domain switch.

Next, it may be determined whether the physical domain corresponding to the desired context is the same as the physical domain of the presently running context (i.e., process) (diamond 420). In one embodiment, such a determination may be made by comparing a domain ID associated with the second process to a hardware register of a processor having the domain ID of the currently running process (for example, hardware register 210 shown in FIG. 3).

If the first and second contexts are both running in the same physical domain, the context switch may be performed (block 430). If instead, the new process is of a different physical domain than the currently running process, the processor register may be updated (block 440). In one embodiment, the processor register may be updated by inserting a domain ID associated with the second physical domain into the processor register from metadata stored in an operating system control structure. Finally, the context switch may be performed (block 450).

In one embodiment, a domain ID of zero may be associated with an operating system, for example, a single homogeneous operating system of a system. When the operating system domain is active (e.g., a hardware register of the processor has a value of zero, indicating that the OS is the currently operating domain), physical addresses in any domain may be accessed (regardless of the partition in which it is contained), in certain embodiments. In yet another embodiment, to access all partitions, not only must a domain ID be equal to an operating system value but also the OS must be operating in a privileged mode (i.e., a privileged mode of 0).

In one embodiment, an OS kernel may include memory management functions and task management functions, such as scheduling and the like. However, other OS services may be implemented in a different domain, such as is done in a microkernel-based OS architecture. In such an embodiment, the OS kernel may have a domain ID of zero and a privilege level of zero. However, other OS services may have a domain level that is not equal to zero, yet a privilege level of zero. In such manner, essential OS memory management and scheduling functions may be in one domain and other OS services may be in another domain such that, while they are privileged, cannot access memory partitions associated with the OS kernel itself.

In one embodiment, a domain may include one or more processes that are to be run in a privileged mode, such as a process requiring execution of interrupts. In accordance with an embodiment of the present invention, such a process may be allowed to perform privileged actions, but be prevented from accessing memory locations of other domains.

Embodiments may be implemented in a program. As such, these embodiments may be stored on a storage medium having stored thereon instructions which can be used to program a system to perform the embodiments. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs), erasable programmable read-only memories (EPROMs), electrically erasable programmable read-only memories (EEPROMs), flash memories, a phase change or ferroelectric memory, a silicon-oxide-nitride-oxide-silicon (SONOS) memory, magnetic or optical cards, or any type of media suitable for storing electronic instructions. Similarly, embodiments may be implemented as software modules executed by a programmable control device, such as a computer processor or a custom designed state machine.

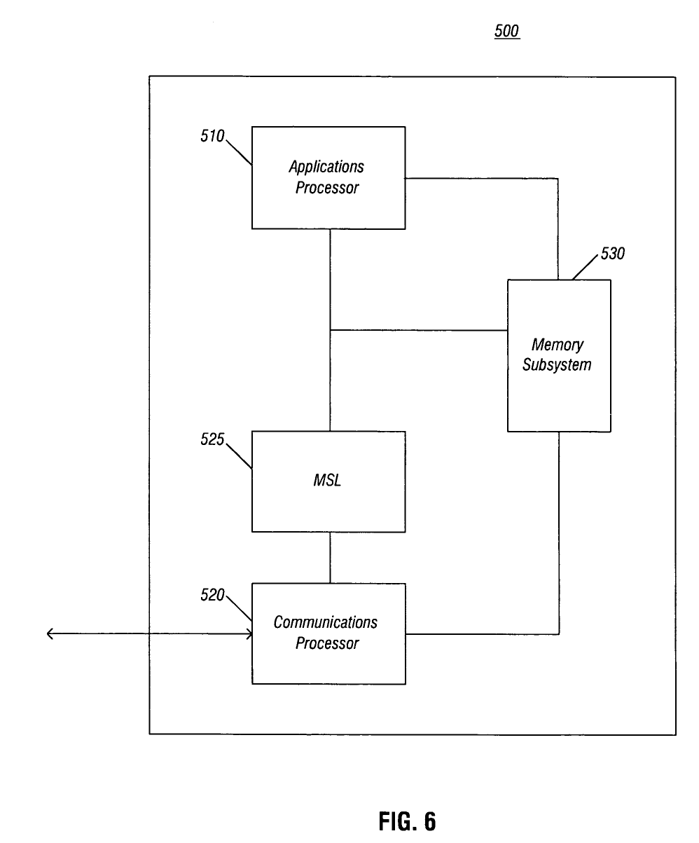

Referring now to FIG. 6, shown is a block diagram of a wireless device with which embodiments of the invention may be used. As shown in FIG. 6, in one embodiment wireless device 500 includes an applications processor 510, which may include a general-purpose or special-purpose processor such as a microprocessor, microcontroller, application specific integrated circuit (ASIC), a programmable gate array (PGA), and the like. Applications processor 510 may be used to execute various applications such as data processing functions, modification and manipulation of digital content and the like. In one embodiment, applications processor 510 may be a 32-bit processor, such as an XSCALE™ processor, available from Intel Corporation, Santa Clara, Calif.

Applications processor 510 may be coupled to a communications processor 520, which may be a digital signal processor (DSP) based on a micro signal architecture, via an internal bus, which may include a scalable link 525 (such as a mobile scalable link), which may be formed of a plurality of gating devices to scalably transfer data between the processors. A memory subsystem 530 may be coupled to both applications processor 510 and communications processor 520, in certain embodiments. Memory subsystem 530 may include both volatile and nonvolatile memory, such as static RAM (SRAM), dynamic RAM (DRAM), flash memories, and the like. While shown in FIG. 6 as separate components, it is to be understood that in other embodiments two or more of the components may be integrated into a single device, such as a single semiconductor device.

It is to be understood that communications processor 520 may include various functionalities including wireless communication with external sources. For example, communications processor 520 may include a wireless interface (which in turn may have an antenna which, in various embodiments, may be a dipole antenna, helical antenna, global system for wireless communication (GSM) or another such antenna). In certain embodiments, the wireless interface may support General Packet Radio Services (GPRS) or another data service. GPRS may be used by wireless devices such as cellular phones of a 2.5 generation (G) or later configuration.

Other embodiments of the present invention may be implemented in a circuit switched network such as used by 2G technologies, a Personal Communications System (PCS) network, a Universal Wireless Telecommunications System (UMTS), or UMTS Telecommunications Radio Access (UTRA) network or other communication schemes, such as a BLUETOOTH™ protocol or an infrared protocol (such as Infrared Data Association (IrDA)).

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
directly mapping a first physical domain to a first plurality of physical partitions of memory.

2. The method of claim 1, further comprising directly mapping a second physical domain to a second plurality of physical partitions of memory.

3. The method of claim 2, further comprising preventing a first process of the first physical domain from accessing a memory location of the second physical domain.

4. The method of claim 1, wherein directly mapping the first physical domain comprises associating a domain identification with each of the first plurality of physical partitions.

5. The method of claim 4, further comprising storing the domain identification and an identifier of each of the first plurality of physical partitions in a storage medium.

6. The method of claim 5, further comprising accessing the storage medium to determine if a memory location is in the first physical domain.

7. The method of claim 5, further comprising comparing a value of a hardware register to entries in the storage medium to determine whether to allow access to memory of the first physical domain.

8. An apparatus comprising:
at least one memory device having a single operating system to manage a plurality of processes in at least one of multiple physical domains of the apparatus.

9. The apparatus of claim 8, further comprising a first physical domain having a first plurality of partitions, the first physical domain to include at least one trusted process.

10. The apparatus of claim 9, further comprising a second physical domain having a second plurality of partitions, the second physical domain to include at least one untrusted process.

11. The apparatus of claim 8, further comprising a storage medium to store entries for partitions of the multiple physical domains.

12. The apparatus of claim 11, further comprising a processor coupled to the storage medium, the processor having a register to store an identification of an active one of the multiple physical domains.

13. A method comprising:
maintaining a process of a first physical domain separate from memory of a second physical domain.

14. The method of claim 13, wherein maintaining the process comprises preventing the process from accessing a memory location of the second physical domain.

15. The method of claim 13, further comprising allowing the process to access any memory partition of the first physical domain.

16. The method of claim 13, further comprising switching from the process to a second process of the second physical domain.

17. The method of claim 16, further comprising allowing the second process to access a memory location of the first physical domain if the second process is an operating system process.

18. The method of claim 13, further comprising forming the first physical domain from a first plurality of memory partitions and the second physical domain from a second plurality of memory partitions.

19. A method comprising:
executing a first process in a first physical domain; and
executing a second process in a second physical domain.

20. The method of claim 19, further comprising executing the first process and the second process using a single operating system.

21. The method of claim 19, wherein executing the first process comprises executing a trusted application.

22. The method of claim 21, wherein executing the second process comprises executing an untrusted application.

23. The method of claim 19, further comprising executing processes in n physical domains, wherein n is greater than two.

24. The method of claim 20, further comprising executing multiple processes in each of the first physical domain and the second physical domain.

25. The method of claim 19, further comprising preventing the first process from accessing a memory location of the second physical domain.

26. The method of claim 19, wherein the first physical domain comprises a first plurality of memory partitions and the second physical domain comprises a second plurality of memory partitions.

27. An apparatus comprising:
a domain structure having a plurality of entries, wherein each of the plurality of entries identifies a memory partition and a corresponding physical domain.

28. The apparatus of claim 27, wherein the domain structure comprises a storage medium.

29. The apparatus of claim 28, wherein the storage medium comprises a cache.

30. The apparatus of claim 27, further comprising a buffer coupled to the domain structure to store recently used ones of the plurality of entries.

31. The apparatus of claim 27, further comprising a processor coupled to the domain structure, the processor having a register to store an identification of a current physical domain.

32. The apparatus of claim 27, further comprising a processor coupled to the domain structure, the processor having a plurality of cores each having a register to store an identification of a current physical domain for one of the plurality of cores.

33. A method comprising:
qualifying access to a physical address using a domain identifier of a running process.

34. The method of claim 33, wherein qualifying the access comprises comparing the domain identifier to a corresponding entry in a domain structure.

35. The method of claim 34, further comprising permitting the access if the corresponding entry includes a matching domain identifier.

36. The method of claim 34, further comprising preventing the access if the corresponding entry does not include a matching domain identifier.

37. The method of claim 34, further comprising performing a domain table walk if the corresponding entry is not in a domain buffer.

38. An article comprising a machine-readable medium containing instructions that if executed enable a system to:
directly map a first physical domain to a first plurality of physical partitions of memory.

39. The article of claim 38, further comprising instructions that if executed enable the system to directly map a second physical domain to a second plurality of physical partitions of memory.

40. The article of claim 39, further comprising instructions that if executed enable the system to prevent a first process of the first physical domain from accessing a memory location of the second physical domain.

41. An apparatus comprising:
a register to store an identification of a current physical domain of the apparatus.

42. The apparatus of claim 41, further comprising a processor associated with the register.

43. The apparatus of claim 42, further comprising a domain structure coupled to the processor having a plurality of entries, wherein each of the plurality of entries identifies a memory partition and a corresponding physical domain.

44. The apparatus of claim 43, wherein the domain structure comprises a cache associated with the processor.

45. A system comprising:
a register to store an identification of a current physical domain of the apparatus; and
a wireless interface coupled to the register.

46. The system of claim 45, further comprising a processor associated with the register.

47. The system of claim 46, further comprising a domain structure coupled to the processor having a plurality of entries, wherein each of the plurality of entries identifies a memory partition and a corresponding physical domain.

48. The system of claim 45, wherein the wireless interface comprises an antenna.
